(19) United States
(12) Patent Application Publication
(10) Pub. No.: US 2010/0060715 A1
(43) Pub. Date: Mar. 11, 2010

(54) Communication system and method

(75) Inventors: Marek Laasik, Tallinn (EE); Madis Kaal, Tallinn (EE)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Skype Limited, Dublin (IE)

(21) Appl. No.: 12/455,635

(22) Filed: Jun. 4, 2009

(30) Foreign Application Priority Data
Sep. 5, 2008 (GB) 0816271.1

(51) Int. Cl. H04N 7/14

(52) U.S. Cl. 348/14.04; 370/352; 348/E07.082

(57) ABSTRACT

A television receiver system, comprising: a television receiver operable to receive broadcast video signals; a memory storing a communication client application; a processor, coupled to the memory and operable to execute the communication client application, wherein the communication client application is programmed so as when executed to allow a user to establish a video call with one or more other users via a packet-based communication network; a video buffer operable to buffer video data for display on a television screen; and selection means having a first input arranged to receive broadcast video data from the television receiver, a second input arranged to receive video call data from the communication client, an output connected to the video buffer, and a control input connected to the communication client, wherein the selection means is arranged to output the broadcast video data to the video buffer in the absence of a selection signal at the control input, and wherein the communication client is arranged to generate a selection signal to control the selection means to output the video call data to the video buffer responsive to receiving a command to establish a video call from the user.

This invention relates to a communication system and method.

Packet-based communication systems allow the user of a device, such as a personal computer, to communicate across a computer network such as the Internet. Packet-based communication systems include voice over internet protocol (“VoIP”) communication systems. These systems are beneficial to the user as they are often of significantly lower cost than fixed line or mobile networks. This may particularly be the case for long-distance communication. To use a VoIP system, the user must install and execute client software on their device. The client software provides the VoIP connections as well as other functions such as registration and authentication. In addition to voice communication, the client may also provide further features such as video calling, instant messaging (“IM”), SMS messaging, and voicemail.

One type of packet-based communication system uses a peer-to-peer (“P2P”) topology built on proprietary protocols. To enable access to a peer-to-peer system, the user must execute P2P client software provided by a P2P software provider on their computer, and register with the P2P system. When the user registers with the P2P system the client software is provided with a digital certificate from a server. Once the client software has been provided with the certificate, communication can subsequently be set up and routed between users of the P2P system without the further use of a server. In particular, the users can establish their own communication routes through the P2P system based on the exchange of one or more digital certificates (or user identity certificates, “UIC”), which enable access to the P2P system. The exchange of the digital certificates between users provides proof of the users' identities and that they are suitably authorised and authenticated in the P2P system. Therefore, the presentation of digital certificates provides trust in the identity of the user. It is therefore a characteristic of peer-to-peer communication that the communication is not routed using a server but directly from end-user to end-user. Further details on such a P2P system are disclosed in WO 2005/009019.

A problem with packet-based communication systems is that the accessibility of packet-based communication systems for users is limited. In particular, such systems are most commonly accessed using a personal computer. This has the disadvantage that the user must be sufficiently technically competent to download and install the packet-based communication client software on their personal computer, which provides a barrier to the take-up of the use of the packet-based communication system. Even when the communication client is installed and executed on a personal computer, the use of the packet-based communication system may be limited because personal computers are often not located in a place where the user is either familiar or comfortable with communicating. For example, a personal computer is often located in a study, which is not the most natural or familiar environment for making calls for many users.

Whilst packet-based communication systems can also be accessed via certain mobile devices, these generally do not have processing resources or display screens available to offer a full range of features, such as video calling.

There is therefore a need for a technique to address the aforementioned problems with the accessibility of packet-based communication systems.

According to one aspect of the present invention there is provided a television receiver system, comprising: a television receiver operable to receive broadcast video signals; a memory storing a communication client application; a processor, coupled to the memory and operable to execute the communication client application, wherein the communication client application is programmed so as when executed to allow a user to establish a video call with one or more other users via a packet-based communication network; a video buffer operable to buffer video data for display on a television screen; and selection means having a first input arranged to receive broadcast video data from the television receiver, a second input arranged to receive video call data from the communication client, an output connected to the video buffer, and a control input connected to the communication client, wherein the selection means is arranged to output the broadcast video data to the video buffer in the absence of a selection signal at the control input, and wherein the communication client is arranged to generate a selection signal to control the selection means to output the video call data to the video buffer responsive to receiving a command to establish a video call from the user.

Because the video call data is sent to the same video buffer as the TV video data, the video call data is displayed in full screen on the TV, enabling the user to easily and comfortably view the video call. In addition, by providing the video call data to the same video buffer used for TV video data, the amount of hardware changes required to existing TV designs is minimised. The action of displaying the video call on the TV screen is intuitive and familiar to the users, as it is similar to changing a channel using a TV remote control.

The communication client may be arranged to connect the video call over the packet-based communication network responsive to receiving the command to establish the video call. The communication client may be further arranged to generate a selection signal to control the selection means to revert to the output of the broadcast video data to the video buffer responsive to the communication client receiving a command to terminate the video call.

Preferably, the communication client is arranged to control the selection means to output the broadcast video data to the video buffer responsive to the communication client receiving a command to reject the video call and establish an audio call.

In one embodiment, the command to establish a video call from the user input means is a command to initiate an outgoing video call. In another embodiment, the command to establish a video call from the user input means is a command to accept an incoming video call received at the communication client over the packet-based communication network.

The communication client application may be arranged to generate a user interface for output on a television screen. Preferably, the communication client is arranged to generate a notification of the incoming video call on the user interface responsive to receiving the incoming video call. Preferably, the user interface comprises a list of one or more other users of the packet-based communication network associated with the user.

The television receiver system may further comprise a remote control unit comprising at least one wireless communication means arranged to transmit data to the processor, a control means coupled to the wireless communication means and configured to control the wireless communication means, and user input means coupled to the control means and arranged to receive input commands from the user and provide the input commands to the control means.

Preferably, the command to establish a video call is received at the control means from the user input means, and transmitted to the communication client using the at least one wireless communication means. Preferably, the remote control unit further comprises a microphone coupled to the control means and arranged to receive audio signals from the user.

The microphone may be retractable from the remote control unit, and the control means may be arranged to generate the command to establish the video call responsive to the user retracting the microphone and transmit the command to establish the video call to the communication client using the at least one wireless communication means.

Preferably, the at least one wireless communication means comprises at least one of a radio transmitter and an infra-red transmitter.

The communication client application may be arranged to decode audio and video packets received at the processor over the packet-based communication network as audio and video data. The communication client application may be arranged to encode audio and video signals received at the processor as voice over internet protocol packets and video packets for transmission over the packet-based communication network.

Preferably, the communication client application is programmed to allow the user to establish calls via a peer-to-peer connection in the packet based communication network.

Preferably, the television receiver system comprises one of a television set and a set-top box arranged to connect to a television set.

According to another aspect of the present invention there is provided a media appliance, comprising: a video playback device operable to retrieve stored video data from a storage location; a memory storing a communication client application; a processor, coupled to the memory and operable to execute the communication client application, wherein the communication client application is programmed so as when executed to allow a user to establish a video call with one or more other users via a packet-based communication network; a video buffer operable to buffer video data for display on a television screen; and selection means having a first input arranged to receive stored video data from the video playback device, a second input arranged to receive video call data from the communication client, an output connected to the video buffer, and a control input connected to the communication client, wherein the communication client is arranged to control the selection means to output the video call data to the video buffer responsive to the communication client receiving a command to establish a video call from the user.

The media appliance may comprise one of a video disc player arranged to connect to a television set, a personal video recorder arranged to connect to a television set, and a games console arranged to connect to a television set.

According to another aspect of the present invention there is provided a method of controlling video signals in a television receiver system having a processor executing a communication client, comprising: receiving broadcast video signals at a television receiver and providing broadcast video data from the television receiver to a first input of a selection means; outputting the broadcast video data from the selection means to a video buffer in the absence of a selection signal at a control input of the selection means; receiving a command to establish a video call from a user at the communication client and providing video call data to a second input of the selection means; responsive to receiving the command to establish a video call, the communication client generating a selection signal to control the selection means to output the video call data to the video buffer.

The method may further comprise the step of the communication client connecting the video call over the packet-based communication network responsive to receiving the command to establish the video call.

The method may further comprise the step of the communication client generating a selection signal to control the selection means to revert to the output of the broadcast video data to the video buffer responsive to the communication client receiving a command to terminate the video call.

The method may further comprise the step of the communication client controlling the selection means to output the broadcast video data to the video buffer responsive to the communication client receiving a command to reject the video call and establish an audio call.

The method may further comprise the step of the communication client application generating a user interface for output on a television screen.

The method may further comprise the step of the communication client generating a notification of the incoming video call on the user interface responsive to receiving the incoming video call.

Preferably, the television receiver system further comprises a remote control unit, and the step of receiving the command to establish a video call comprises: receiving the command to establish a video call at a control means of the remote control unit from a user input means of the remote control unit; and transmitting the command to establish a video call to the communication client using at least one wireless communication means of the remote control unit.

Preferably, the remote control unit further comprises a microphone for receiving audio signals from the user. Preferably, the microphone is retractable from the remote control unit, and method may further comprise the steps of: the control means generating the command to establish the video call responsive to the user retracting the microphone; and transmitting the command to establish the video call to the communication client using the at least one wireless communication means.

The method may further comprise the step of the communication client application decoding audio and video packets received at the processor over the packet-based communication network as audio and video data.

The method may further comprise the step of the communication client application encoding audio and video signals received at the processor as voice over internet protocol packets and video packets for transmission over the packet-based communication network.

According to another aspect of the present invention, there is provided a method of controlling video signals in a media appliance having a processor executing a communication client, comprising: retrieving stored video data from a storage location using a video playback device and providing the stored video data from the video playback device to a first input of a selection means; outputting the stored video data from the selection means to a video buffer in the absence of a selection signal at a control input of the selection means; receiving a command to establish a video call from a user at the communication client and providing video call data to a second input of the selection means; responsive to receiving the command to establish a video call, the communication client generating a selection signal to control the selection means to output the video call data to the video buffer.

According to another aspect of the present invention, there is provided a computer program product comprising program code means which, when executed by a computer, implement the steps according to any of the methods discussed above.

For a better understanding of the present invention and to show how the same may be put into effect, reference will now be made, by way of example, to the following drawings in which:

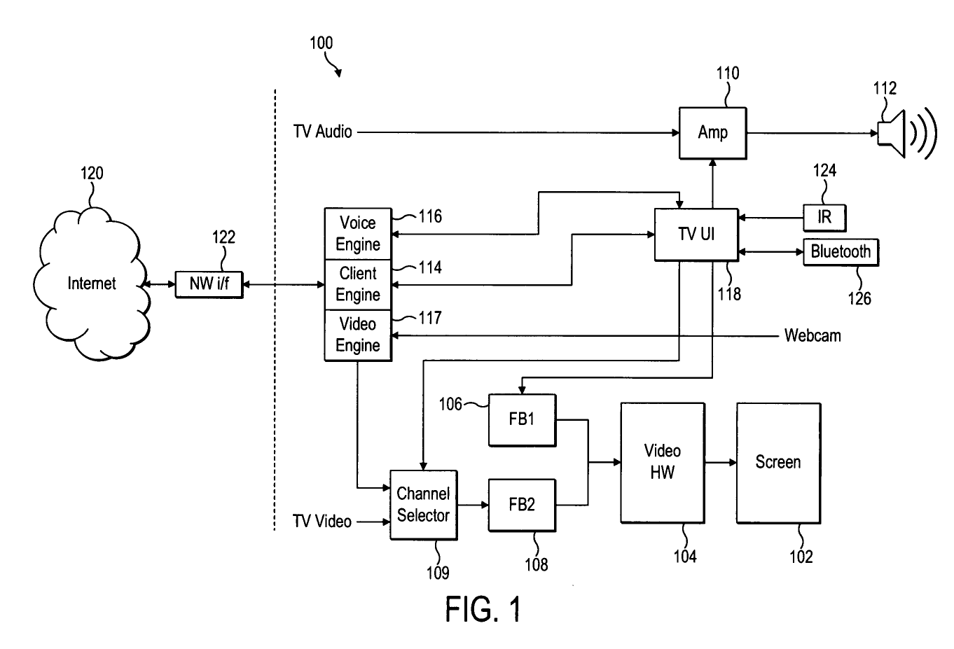

FIG. 1 is a block diagram showing the functional blocks of a TV with an embedded communication client;

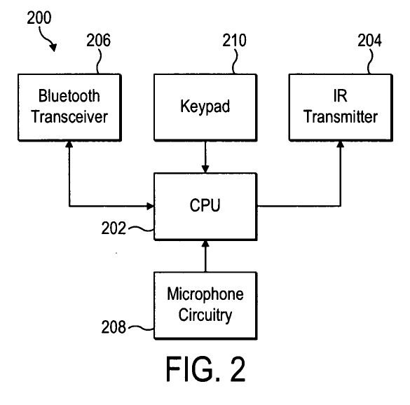

FIG. 2 is a block diagram showing the functional blocks of a remote control unit for use with the TV of FIG. 1;

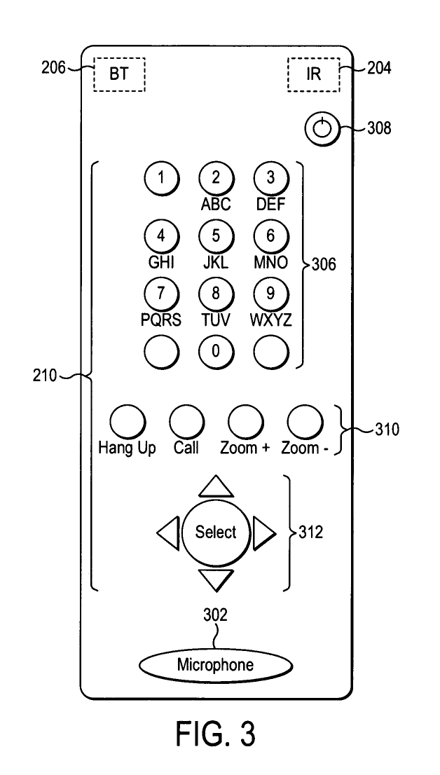

FIG. 3 shows the physical layout of a remote control unit;

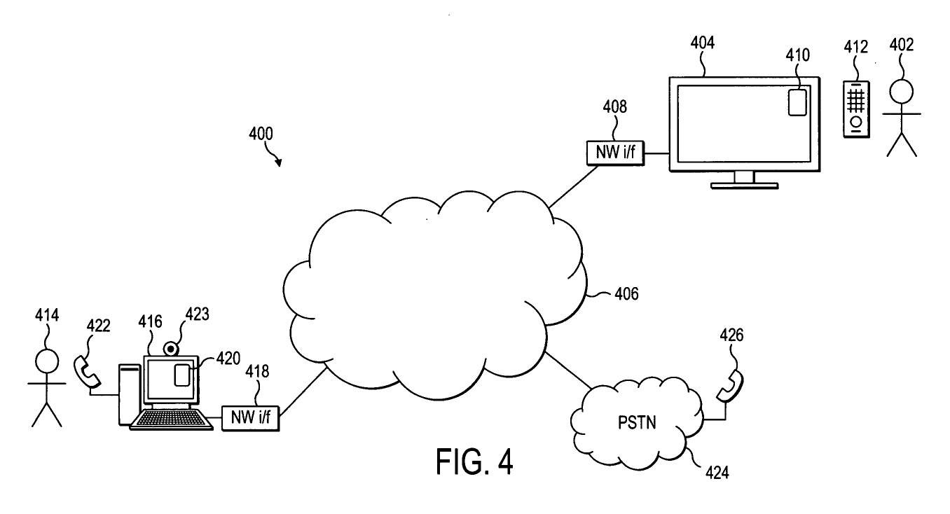

FIG. 4 shows an illustrative packet-based communication system;

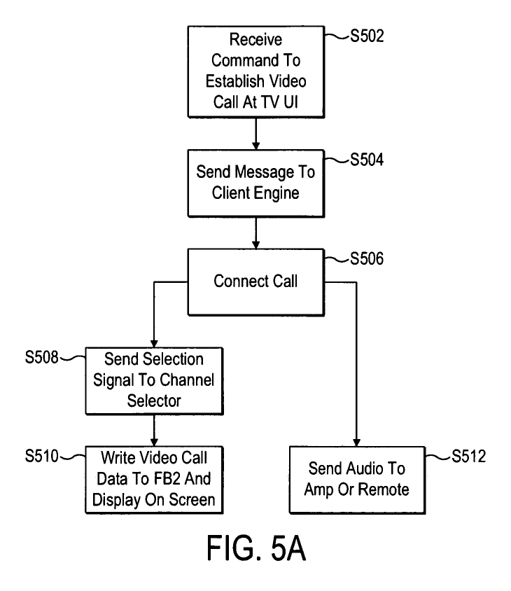

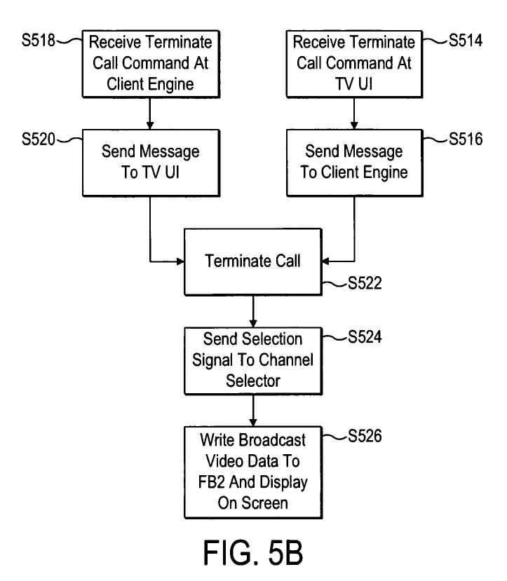

FIG. 5A shows a flowchart for a process of controlling video signals when a call is established;

FIG. 5B shows a flowchart for a process of controlling video signals when a call is terminated; and

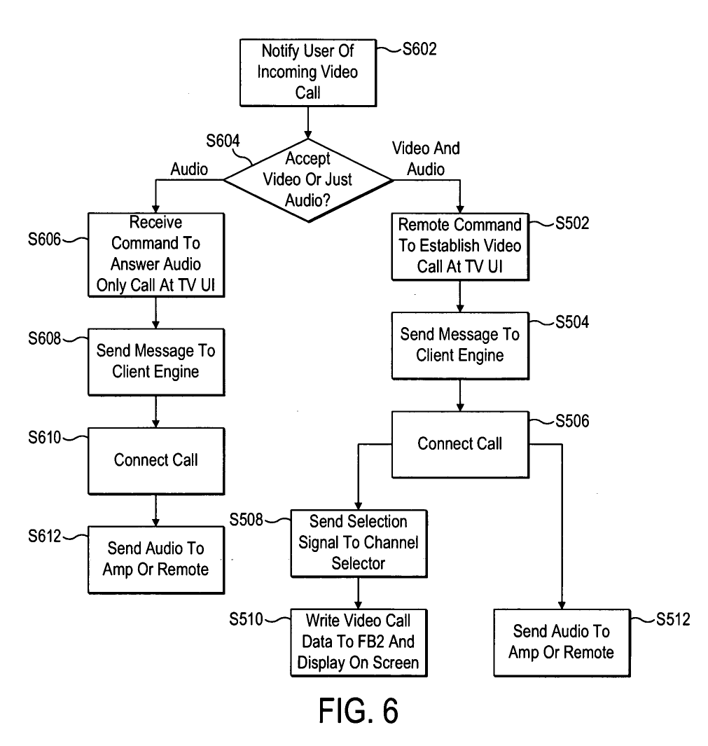

FIG. 6 shows a flowchart of an alternative embodiment for a process of controlling video signals when a call is established;

In order to overcome the above-mentioned problems with packet-based communication systems, a technique has been developed to enable a user to access such systems from a television (“TV”). This is achieved either by embedding the communication client into the TV itself, or through a separate set-top box (“STB”) connected to the TV. In alternative embodiments, the embedded communication client can reside in another device connected to a TV, such as a games console or video playback device (e.g. a video disc player or a personal video recorder).

This is advantageous because the TV can be provided with all the embedded hardware and software required to access the packet-based communication system built-in. Alternatively, this can be embedded into a STB (or other TV-connected device) which is readily connected to an existing TV using known interfaces (such as HDMI, SCART or component interfaces, for example). This eliminates the need for the user to download and install software on their personal computer, and provides a simpler method by which non-technical users can access the packet-based communication system in their home. In addition, the TV is typically located in a living room of a house, which enables the packet-based communication system to be accessed from the location in the house which is most familiar to many users for communicating with friends and relatives due to this being the traditional location for landline PSTN telephones.

The embedding of a packet-based communication client in a TV also has the advantage that a large screen is present, which can be utilised for video calling. Furthermore, significant processing power can be provided in the TV, particular as the power requirements for a large, mains electricity powered consumer electronics device are less stringent than, for example mobile devices. This enables a full range of features to be included in the embedded communication client, such as high quality voice and video encoding.

The remote control of the TV is enhanced to provide functionality which enables the user to make and receive calls, as well as send and receive messages using the TV.

However, known TVs are not designed to support video calling functionality. In particular, known TVs do not comprise a mechanism whereby a video signal (such as broadcast TV or a stored video being played) can be interrupted to display a video call. In addition, users of the TV need to be able to simply control the communication client so that the video call is easily viewed when desired. In addition, it is advantageous to be able display an incoming video call stream utilising the full TV screen, as this enables the user to view the video call clearly, without needing to be too close to the TV.

Reference is now made to FIG. 1, which illustrates the hardware and software functional blocks embedded in a TV 100. The TV 100 comprises a screen 102 for displaying images to the user, which is driven by video driver hardware 104 arranged to convert the video signals into the form required to be correctly displayed on the screen 102. The video driver hardware 104 is provided with digital video data from two frame buffers 106 and 108. The frame buffers 106 and 108 are storage devices that buffer video data that is to be displayed to the user.

Frame buffer 1 (“FB1”) 106 stores video data related to the packet-based communication client. In particular, FB1 106 buffers video information that is used to present a graphical user interface for the communication client on the TV screen 102.

Frame buffer 2 (“FB2”) 108 stores video data that is to be displayed full-screen on the TV screen 102. Typically, FB2 buffers standard TV video signals, as is known for the display of broadcast TV. However, FB2 receives video signals output from a channel selector 109. The channel selector 109 selects one of a plurality of video signals to be input to FB2 108. In other words, the channel selector 109 acts as a video source switch for controlling the video source that is displayed in full-screen on the screen 102. The channel selector 109 receives as input a standard TV video signal (described below) and an output from a video engine, described hereinafter. Note that the channel selector 109 outputs the TV signal to FB2 108 in its default state.

An audio amplifier 110 receives TV audio signals and amplifies these for output through at least one speaker 112.

The TV audio and video input signals themselves originate from television signals broadcast via any suitable means such as a satellite repeater stations, wireless terrestrial repeater stations or cable; and received by a television receiver unit of the TV 100 (not shown). Note that broadcasting is distinct from point-to-point communication, including being distinct from multicasting (i.e. point-to-multipoint). In broadcasting, signals are transmitted indiscriminately, i.e. regardless of whether the user has selected to receive the signal (although a decryption key or such like may still be required so that only authorised users can access the broadcast); whereas in point-to-point communication, signals must be requested by the user or users receiving them. Or put another way, to receive a broadcast a user simply “tunes in” without needing to send any signal to the broadcaster, whereas to establish a point-to-point connection then signals must be exchanged between the user and broadcaster.

The TV receiver unit may comprise for example an antenna, satellite dish or cable input; sampling circuitry; a filter; a low noise amplifier; a mixer, and/or an analogue to digital converter.

After being received by the receiver unit, the signals are then processed by a signal processing apparatus (also not shown) before being input to the frame buffers and amplifiers of FIG. 1. The signal processing may comprise for example a digital filter, demultiplexer, decoder, decryption block, and/or error checking block; which may be implemented in on-chip hardware in the form of one or more on-chip peripherals (not shown), off-chip hardware in the form of one or more off-chip units accessed via one or more of the I/O peripherals, or in software stored in a memory and executed on a central processing unit (CPU) of the television 100 (not shown), or in any combination of these.

The packet-based communication client embedded in the TV 100 is based around four main elements. Preferably, these four elements are software elements that are executed on a processor and stored in a memory. The four elements are: a client engine 114; a voice engine 116; a video engine 117; and a TV user interface 118.

The client engine 114 is responsible for setting up connections to the packet-based communication system. This is performed via a connection from the TV 100 to the internet 120. The TV 100 is connected to the internet 120 via a network interface 122 such as a modem, and the connection between the TV 100 and the network interface 122 may be via a cable (wired) connection or a wireless connection. The client engine 114 performs call set-up, authentication, encryption and connection management, as well as other functions relating to the packet-based communication system such as firewall traversal, presence state updating, and contact list management.

The voice engine 116 is responsible for the encoding of voice signals input to the TV 100 as VoIP packets for transmission over the internet 120 and the decoding of VoIP packets received from the internet 120 for presentation as audio information to the user of the TV 100.

The video engine 117 is responsible for the encoding of video signals input to the TV (e.g. from a webcam or other video camera) as video packets for transmission over the internet 120 in a video call, and the decoding of video packets received from the internet 120 in a video call for presentation as video images to the user of the TV 100.

The TV user interface (“UI”) 118 is responsible for presenting visual information to the user of the TV 100 in the form of a graphical user interface displayed on the TV screen 102.

The client engine 114 is connected to the TV UI 118 in order to control what the UI displays to the user. The client engine 114 is also closely integrated with the voice engine 116 and video engine 117 for the efficient transmission and receiving of voice and video packets over the internet.

The voice engine 116 is connected to the TV UI 118 as voice signals from the user are passed through the TV UI 118 to the voice engine 116, and vice versa. The video engine 117 is connected to the channel selector 109 for providing video data to be displayed on the TV screen 102.

The TV UI 118 is connected to FB1 106, so that the graphical user interface data is buffered and displayed to the user on the screen 102. The TV UI 118 is also connected to the amplifier 110, enabling sound (such as voice signals or notifications) to be produced from the TV speakers 112. The TV UI 118 is also connected to an infra-red (“IR”) receiver 124 and a Bluetooth transceiver 126 which are used for communicating with a remote control unit, as will be discussed below.

The TV UI 118 is also connected to the channel selector 109. This controls which of the inputs to the channel selector 109 is provided to FB2 108, such that a particular video source is displayed on the TV screen 102.

Note that if the embedded communication client is provided in the form of a STB (or other TV-connected device) for connection to a TV, then the system in FIG. 1 differs only in that the screen 102, amplifier 110 and speaker 112 (and optionally the video driver hardware 104) blocks are located in the TV itself, whereas the remaining functional blocks are located in the set top box, which is connected to the TV.

Reference is now made to FIG. 2, which illustrates the functional blocks of a remote control unit 200 arranged to communicate with the TV 100 of FIG. 1. The remote control unit 200 comprises a central processing unit (“CPU”) 202 arranged to control the operation of the remote control unit 200. In particular, the CPU 202 controls the sending and receiving of data between the TV 100 and the remote control unit 200.

The remote control unit 200 is arranged to communicate with the TV 100 by two different methods. Firstly, the remote control comprises an IR transmitter 204, which sends IR signals to the IR receiver 124 in the TV 100. This is performed in a similar manner to conventional remote control units used with televisions. This has the advantage of being power efficient, which is important for a battery powered device such as a remote control. However, this also has the disadvantage of requiring a line-of-sight signal path and has a low data rate. The IR transmitter 204 is therefore used for sending commands to the TV 100. These commands include conventional TV commands, such as changing channels, switching to standby and adjusting volume, as well as commands relating to the embedded communication client, as will be described hereinafter.

The second method for communicating with the TV 100 is by a Bluetooth connection. The remote control unit 200 comprises a Bluetooth transceiver 206 which is able to communicate with the Bluetooth transceiver 126 located in the TV 100. Bluetooth is a low-power short-range radio standard, and therefore does not require a line-of-sight signal path. Higher data rates are also available for Bluetooth connections, compared to IR. The Bluetooth transceiver 206 is paired with the Bluetooth transceiver 126 located in the TV 100 such that a data connection can be readily formed between them. The data connection enables the transmission of data from the remote control unit 200 to the TV 100, and, optionally, the reception of data from the TV 100 at the remote control unit 200.

The IR transmitter 204 and the Bluetooth transceiver 206 are connected to the CPU 202, and the CPU 202 controls the activation of these units and provides them with the data to be sent (and optionally reads the data received by the Bluetooth transceiver 206).

Also connected to the CPU 202 is microphone circuitry 208. The microphone circuitry 208 is arranged to receive audio information such as speech from the user of the remote control unit 200 and provide the audio information to the CPU 202 for processing. The audio information can be speech which is subsequently sent to the TV 100, and transmitted over the internet as VoIP packets, as will be described in more detail hereinafter. The microphone circuitry 208 comprises a microphone, an amplifier, and an analogue-to-digital converter for generating a digital representation of the audio signals which can be input to the CPU 202.

Also connected to the CPU 202 is a keypad 210, which enables the user to enter commands to the remote control unit 200.

Optionally connected to the CPU 202 is speaker circuitry. The speaker circuitry is arranged to receive audio data from the CPU 202 and generate audible sound that the user of the remote control can hear. The speaker circuitry can comprise a digital-to-analogue converter, an amplifier and a speaker. The speaker circuitry can be used to enable the user of the remote control unit 200 to hear voice calls from a remote party over the internet, as will be described later.

Reference is now made to FIG. 3, which illustrates the physical layout of the remote control unit 200. The remote control unit 200 resembles conventional remote controls for TVs. However, the remote control unit 200 includes an integrated microphone 302, and, optionally, an integrated speaker (not shown). This enables the remote control unit 200 to be held to the head of the user in a similar manner to a conventional telephone. Integrated within the unit are an IR transmitter 204 and Bluetooth transceiver 206, as described above.

The remote control unit 200 comprises a keypad 210, as mentioned above. The keypad 210 comprises a numeric keypad 306, which is used for conventional TV control purposes, and also for entering information for the embedded packet-based communication client. The numeric keypad 306 comprises numbered keys that can also be used to enter alphabetic characters. A standby button 308 is used for placing the TV 100 into standby mode. Dedicated function keys 310 are used to control the operation of the packet-based communication client, and a directional pad 312 is used for navigating the TV user interface.

In order to describe the operation of the TV 100 and enhanced remote control unit 200 with the packet based communication system, and particularly the operation of the enhanced UI, reference is now made to FIG. 4, which illustrates the use of the TV 100 in a portion of an example system 400.

Note that whilst the illustrative embodiment shown in FIG. 4 is described with reference to a P2P communication system, other types of non-P2P communication system could also be used. The system 400 shown in FIG. 4 shows a first user 402 of the communication system operating a TV 404, which is shown connected to a network 406. Note that the communication system 400 utilises a network such as the Internet. The TV 404 is connected to the network 406 via a network interface 408 such as a modem, and the connection between the user terminal 104 and the network interface 108 may be via a cable (wired) connection or a wireless connection. The TV 404 shown in FIG. 4 is a standalone unit, but it should be appreciated that a separate TV and STB (or other TV-connected device) can also be used.

The TV 404 is executing an embedded communication client 410. Note that in alternative embodiments, the embedded communication client can be executed in a set top box. The embedded communication client 410 comprises software executed on a local processor in the TV 404.

The TV 404 is arranged to receive information from and output information to the user 402. A remote control unit 412 acts as the input device operated by the user 402 for the control of the TV 404. The remote control 412 comprises a microphone and (optionally) a speaker to enable the user to speak and (optionally) listen in a voice or video call. The remote control unit 412 communicates wirelessly with the TV 404, as described previously.

The TV 404 can also receive broadcast television signals, and display these as video (television programmes) to the user on the TV screen. The broadcast television signals can be delivered by terrestrial, satellite or cable broadcasting, and be in the form of analogue signals or digital data. The user 402 can control the display of the television signals (e.g. which channels to display) using the remote control unit 412.

The embedded communication client 410 is arranged to establish and manage voice and video calls made over the packet-based communication system using the network 406. The embedded communication client 410 is also arranged to present information to the user 402 on the screen of the TV 404 in the form of a user interface. The user interface comprises a list of contacts associated with the user 402. Each contact in the contact list has a presence status chosen by the contact associated with it, and each of these contacts have authorised the user 402 of the client 410 to view their contact details and contact defined presence state.

The contact list for the users of the packet-based communication system is stored in a contact server (not shown in FIG. 4). When the client 410 first logs into the communication system the contact server is contacted, and the contact list is downloaded to the client 410. This allows the user to log into the communication system from any terminal and still access the same contact list. The contact server is also used to store a mood message (a short user-defined text-based status that is shared with all users in the contact list) and a picture selected to represent the user (known as an avatar). This information can be downloaded to the client 410, and allows this information to be consistent for the user when logging on from different terminals. The client 410 also periodically communicates with the contact server in order to obtain any changes to the information on the contacts in the contact list, or to update the stored contact list with any new contacts that have been added.

Also connected to the network 406 is a second user 414. In the illustrative example shown in FIG. 4, the user 404 is operating a user terminal 416 in the form of a personal computer. Note that in alternative embodiments, other types of user terminal can also be connected to the packet-based communication system. In addition to personal computers (“PC”) (including, for example, Windows™, Mac OS™ and Linux™ PCs), a personal digital assistant (“PDA”), a mobile phone, or a gaming device could also be connected. In a preferred embodiment of the invention the user terminal 416 comprises a display such as a screen and an input device such as a keyboard, mouse, joystick and/or touch-screen. The user device 416 is connected to the network 406 via a network interface 418 such as a modem.

Note that in alternative embodiments, the user terminal 416 can connect to the communication network 406 via additional intermediate networks not shown in FIG. 4. For example, if the user terminal 416 is a mobile device, then it can connect to the communication network 406 via a mobile network (for example a GSM or UMTS network).

The user terminal 416 is running a communication client 420, provided by the software provider. The communication client 420 is a software program executed on a local processor in the user terminal 416 comprising similar elements to the embedded communication client 410. The communication client 420 enables the user terminal 416 to connect to the packet-based communication system. The user terminal 416 is also connected to a handset 422, which comprises a speaker and microphone to enable the user to listen and speak in a voice call. The microphone and speaker does not necessarily have to be in the form of a traditional telephone handset, but can be in the form of a headphone or earphone with an integrated microphone, as a separate loudspeaker and microphone independently connected to the user terminal 416, or integrated into the user terminal 416 itself. The user terminal 416 is also connected to a video camera 423, such as a webcam, which enables video images from the user terminal 416 to be sent in a video call.

Presuming that the first user 402 is listed in the contact list of the client 420 presented to second user 414, then the second user 414 can initiate a video call to the first user 402 over the communication system by selecting the contact and clicking on a “video call” button using a pointing device such as a mouse. The call set-up is performed using proprietary protocols, and the route over the network 406 between the calling user and called user is determined by the peer-to-peer system without the use of servers.

Following authentication through the presentation of digital certificates (to prove that the users are genuine subscribers of the communication system—described in more detail in WO 2005/009019), the call can be established.

Referring again to FIGS. 1 and 2, when the incoming video call is received at the client engine 114 the TV UI 118 is notified of the incoming video call. This places the TV UI 118 into an incoming call state, such that key presses from remote are interpreted appropriately for this state. The TV UI 118 outputs graphics to the FB1 106 to display a notification of the incoming video call on the TV screen 102, such that the user 402 is aware of the incoming call. The notification may only be active for a predetermined time, after which time the notification will fade and the incoming call state will be deactivated. Note further that the notification method can change depending on whether or not the TV is in standby mode or is active. If the TV 100 is active, the notification is displayed on the screen 102. If the TV is in standby mode, the client engine 114 can control the TV UI 118 to notify the user of an incoming call by producing a sound (via the amplifier 110 and speakers 112), flashing an LED (not shown in FIG. 1) or activating the TV screen 102.

The user 402 can select to answer the incoming video call by pressing a key on the remote control unit 412 or enacting a physical motion such as sliding out a movable microphone unit. The remote control unit detects that the user has selected to accept the incoming call. In response to the user 402 selecting to answer the incoming call the remote control unit 200 transmits a command to the TV 100 using the IR transmitter 204. This command indicates that the user has selected to accept the call (either by pressing a button or performing an action).

In parallel with this, the remote control unit 200 activates the Bluetooth transceiver 206. The Bluetooth transceiver 206 is not activated until it is needed to save battery power consumption. This is because the Bluetooth transceiver 206 is considerably more power-hungry than the IR transmitter 204, and is not required for controlling TV functionality (changing channels etc.), so can be deactivated until it is required for communication functionality.

The Bluetooth transceiver 206 establishes a connection with the Bluetooth transceiver 126 in the TV 100. The microphone circuitry 208 is enabled, such that audio inputs to the microphone are input to the CPU 202. This saves further power at the remote control unit, as the microphone circuitry remains deactivated until it is required for communication functionality.

Reference is now made to FIG. 5A, which illustrates a flowchart of the processes performed at the TV 100 when the user establishes a video call.

In step S502, when the TV UI 118 receives the command transmitted via the IR transmitter 204 at the IR receiver 124, this is interpreted this as a call accept command, since the TV UI 118 is in the incoming call state. Note that in alternative embodiments, the IR command sent from the remote control unit 200 can be omitted, and the establishment of the Bluetooth connection between the TV 100 and the remote 200 can be interpreted as a call accept command instead.

In step S504, the TV UI 118 outputs an “answer call” command to the client engine 114. In response to the “answer call” message, the client engine 114 establishes the call connection with the communication client 420 of the calling user 414 in step S506.

When the video call is established with the second user 414, voice and video packets from the user terminal 416 begin to be received at the client engine 114.

In the case of video packets, video images are captured by the video camera 432, and the client 420 executed on user terminal 416 encodes the video signals into video packets and transmits them across the network 406 to the TV 404. The video packets are received at the client engine 114 and passed to the video engine 117. The video engine 117 decodes the video packets to produce video call data.

In step S508, the TV UI 118 generates and transmits a selection command to the channel selector 109. This selection command causes the channel selector 109 to switch from outputting the TV video signals to FB2 108 to outputting video call data. Note that prior to receiving a selection command from the TV UI 118, the channel selector 109 is set to output the TV video signals to FB2. In other words, the channel selector is arranged to select the TV signals for display by default, and will display these until the TV UI 118 commands it to display otherwise.

In step S510, the video call data is written to FB2 108. The contents of the frame buffer 108 are input to the video hardware and displayed in full-screen on the screen 102. The user 402 therefore sees the video images captured by the video camera 423 displayed on the screen 102. From the perspective of the user 402, the effect of accepting the video call is the same as changing a TV channel, as the user has selected a command using a remote control and the TV video displayed has changed (except that the video displayed is now that of video call and not of a different TV channel).

In parallel with the processing of video packets, voice packets are also handled to provide the audio component of the video call in step S512. In the case of voice packets, when the second user 414 talks into handset 422, the client 420 executed on user terminal 416 encodes the audio signals into VoIP packets and transmits them across the network 406 to the TV 404. The VoIP packets are received at the client engine 114 and passed to the voice engine 116. The voice engine 116 decodes the VoIP packets to produce audio information. The audio information is passed to the TV UI 118.

In one embodiment, the audio information is passed from the TV UI 118 to the amplifier 110, such that the voice from the second user 414 is heard from the TV speakers 112. If the TV 100 is currently being used to watch a TV programme, then the audio from the TV programme can be deactivated. Alternatively, the audio from the call can be mixed with the TV programme audio, which can be decreased in volume.

In an alternative embodiment, if the remote control unit 200 comprises the optional speaker circuitry, as described above with reference to FIG. 2, the audio information from the TV UI 118 can be passed to the Bluetooth transceiver 126 and transmitted to the remote control unit 200. At the remote control unit 200, it is received by the Bluetooth transceiver 206, and interpreted by the CPU 202 and converted to audible signals by the speaker circuitry. The user can then hear the voice of the second user 414 from the speaker (not shown in FIG. 3) in the remote control unit 200. Concurrently with this, the TV UI 118 can control the amplifier 110 to deactivate or decrease the volume of the audio signals of a TV programme that may be being viewed at the same time. Having a speaker located in the remote control unit 200 is advantageous because it enables the user to operate the remote control unit 200 in a manner similar to a traditional telephone handset, which is familiar to the user. In addition, it enables the user to move around while communicating (within the confines of the Bluetooth transceiver range) in a similar manner to a cordless telephone. However, the presence of the speaker circuitry in the remote control unit 200 does give rise to higher power consumption at the remote.

When the user 402 talks into the microphone 302 (shown in FIG. 3), the audio signal is converted to digital data by the microphone circuitry 208 and input to the CPU 202. The CPU 202 controls the Bluetooth transceiver 206 to transmit the audio signal to the Bluetooth transceiver 126 of the TV 100. The transmission of the audio can utilise a standard Bluetooth protocol for transmitting audio information.

Upon receiving the audio information at the Bluetooth transceiver 126, the TV UI 118 passes the audio information to the voice engine 116. The voice engine 116 encodes the audio information as VoIP packets and passes these to the client engine 114. The client engine 114 transmits the VoIP packets to the network 406 via the network interface 408, where they are routed to the communication client 420 running on the user terminal 416 of the second user 414. The client 420 decodes the VoIP packets to produce an audio signal that can be heard by the user 414 using the handset 422.

The user 402 can also be provided with a video camera, which can integrated into the TV or connected thereto. This can be used to send video images to the second user 414, in a similar manner to that described above.

Reference is now made to FIG. 5B, which illustrates a flowchart of the processes performed at the TV 100 when the video call is terminated. The video call can either be terminated by the first user 402 or the second user 414.

The first user 402 can terminate the video call by actuating a button on the remote control unit 200 to hang up or end the call, or alternatively by performing an action such as closing a movable microphone. This command is sent to the TV 100 using the IR transmitter, and is received at the TV UI 118 in step S514. The call termination command is passed to the client engine 114 in S516.

If the second user 414 terminates the video call, then this command is received directly at the client engine 114 over the network 406 in step S518. In S520 a message is transmitted to the TV UI 118 to indicate that call termination.

In S522 the client engine 114 terminates the call. This ceases the reception of video packets at the client engine 114, and hence the video engine 117 does not have video packets to decode to produce video signals. The TV UI 118 sends a signal to the channel selector 109 in step S524 to deselect the video call data from the video engine 117, and select the TV video signals instead. As a result of this, in step S526, the TV video signals are output to FB2 108 and therefore displayed on the TV screen 102 of the video call.

The above-described steps were described with reference to an incoming video call initiated by the second user 414. However, the above-described steps apply equally in the case of a video call initiated by the user 402 of the TV 100. In this case, the remote control unit 200 can also be used for initiating a video call to another party. The TV UI 118 has a “call set up” state which can be entered by the user. The call set up state can be entered by the user selecting a calling functionality option using the remote, for example using a dedicated button on the remote or by navigating to an on-screen option using the directional pad (312 in FIG. 3). Alternatively, the call entry state can be entered by performing a physical action on the remote, such sliding out a movable microphone. In response to this a command is sent to the TV 100 which causes the call entry state to be entered. Typically, the call entry state displays a UI to the user comprising the contact list and a contact name/phone number entry field. The first user 402 can select the second user 414 from the contact list and initiate the video call using the remote control unit. The same steps as outlined above with reference to FIG. 5A are then performed in order to display the incoming video stream from the user 414 on the TV 100.

An alternative embodiment for accepting an incoming video call at the TV 100 is now described with reference to FIG. 6.

An incoming video call is received at the client engine 114 (e.g. from the second user 414), and the client engine 114 provides notification of the incoming video call to the TV UI 118. The TV UI 118 displays a notification of the incoming video call on the user interface displayed on the screen in S602. The notification displayed to the user indicates that the incoming call is a video call, and that the user 402 can either view the video call, or only take the call as a voice call (or reject the call completely—not shown in FIG. 6). This is advantageous, as the user can be using the TV 100 to watch a broadcast TV video, and may not want this to be interrupted to view a video call. However, the user may be willing to accept a voice call instead.

If, in step S604, the user 402 selects to accept an audio call using the remote control unit 200, then this command is received at the TV UI 118 in step S606. The TV UI 118 sends a message to the client engine 114 that a voice call has been accepted in step S608. In step S610, the client engine 114 connects the voice call with the second user 414, and audio information is sent to the amplifier 110 or (optionally) the remote control unit 200 in step S612.

If however, in step S602, the user 402 selects to accept a video call, then the video call is connected and displayed in the same manner as described above in steps S502 to S512 with reference to FIG. 5A.

The above-described system therefore enables video calls to be easily displayed on a TV screen. Because the video call data is sent to the same frame buffer as the TV video data, the video call data is displayed in full screen on the TV, enabling the user to easily and comfortably view the video call. In addition, by providing the video call data to the same frame buffer used for TV video data, the amount of hardware changes required to existing TV designs is minimised. The action of displaying the video call on the TV screen is intuitive and familiar to the users, as it is similar to changing a channel using a TV remote control. The users can also be provided with the option to reject a video call and only take a voice call, which avoids a user having a TV programme interrupted if this is not desired.

While this invention has been particularly shown and described with reference to preferred embodiments, it will be understood to those skilled in the art that various changes in form and detail may be made without departing from the scope of the invention as defined by the appendant claims. In particular, whist the embodiments described above have been described with reference to a TV with an embedded communication client, it should be understood that the client can also be embedded into another type of media device for connection to a TV, such a set top box, a games console or video playback device (e.g. a video disc player or a personal video recorder). Furthermore, whilst the invention has been described in the context of a P2P communication system, it will be understood that the invention can be used in combination with other, non-P2P, packet-based communication systems.

According to the invention in certain embodiments there is provided a method of controlling video signals in a television receiver system as described above having the following features:

The method may comprise the step of the communication client connecting the video call over the packet-based communication network responsive to receiving the command to establish the video call.

The method may comprise the step of the communication client generating a selection signal to control the selection means to revert to the output of the broadcast video data to the video buffer responsive to the communication client receiving a command to terminate the video call.

The method may comprise the step of the communication client controlling the selection means to output the broadcast video data to the video buffer responsive to the communication client receiving a command to reject the video call and establish an audio call.

The command to establish a video call from the user input means may be a command to initiate an outgoing video call.

The command to establish a video call from the user input means may be a command to accept an incoming video call received at the communication client over the packet-based communication network.

The method may comprise the step of the communication client application generating a user interface for output on a television screen.

The method may comprise the step of the communication client generating a notification of the incoming video call on the user interface responsive to receiving the incoming video call.

The user interface may comprise a list of one or more other users of the packet-based communication network associated with the user.

The television receiver system may further comprise a remote control unit, and the step of receiving the command to establish a video call may comprise: receiving the command to establish a video call at a control means of the remote control unit from a user input means of the remote control unit; and transmitting the command to establish a video call to the communication client using at least one wireless communication means of the remote control unit.

The remote control unit may further comprise a microphone for receiving audio signals from the user.

The microphone may be retractable from the remote control unit, and the method may further comprise the steps of: the control means generating the command to establish the video call responsive to the user retracting the microphone; and transmitting the command to establish the video call to the communication client using the at least one wireless communication means.

The method may comprise the step of the communication client application decoding audio and video packets received at the processor over the packet-based communication network as audio and video data.

The method may comprise the step of the communication client application encoding audio and video signals received at the processor as voice over internet protocol packets and video packets for transmission over the packet-based communication network.

The communication client application may be programmed to allow the user to establish calls via a peer-to-peer connection in the packet based communication network.

The television receiver system may comprise one of a television set and a set-top box arranged to connect to a television set.

According to the invention in certain embodiments there is provided a method of controlling video signals in a media appliance as described above having the feature that the media appliance comprises one of a video disc player arranged to connect to a television set, a personal video recorder arranged to connect to a television set, and a games console arranged to connect to a television set.

1. A television receiver system, comprising:
a television receiver operable to receive broadcast video signals;
a memory storing a communication client application;
a processor, coupled to the memory and operable to execute the communication client application, wherein the communication client application is programmed so as when executed to allow a user to establish a video call with one or more other users via a packet-based communication network;
a video buffer operable to buffer video data for display on a television screen; and
selection means having a first input arranged to receive broadcast video data from the television receiver, a second input arranged to receive video call data from the communication client, an output connected to the video buffer, and a control input connected to the communication client,
wherein the selection means is arranged to output the broadcast video data to the video buffer in the absence of a selection signal at the control input, and wherein the communication client is arranged to generate a selection signal to control the selection means to output the video call data to the video buffer responsive to receiving a command to establish a video call from the user.

2. A television receiver system according to claim 1, wherein the communication client is arranged to connect the video call over the packet-based communication network responsive to receiving the command to establish the video call.

3. A television receiver system according to claim 1, wherein the communication client is further arranged to generate a selection signal to control the selection means to revert to the output of the broadcast video data to the video buffer responsive to the communication client receiving a command to terminate the video call.

4. A television receiver system according to claim 1, wherein the communication client is arranged to control the selection means to output the broadcast video data to the video buffer responsive to the communication client receiving a command to reject the video call and establish an audio call.

5. A television receiver system according to claim 1, wherein the command to establish a video call from the user input means is a command to initiate an outgoing video call.

6. A television receiver system according to claim 1, wherein the command to establish a video call from the user input means is a command to accept an incoming video call received at the communication client over the packet-based communication network.

7. A television receiver system according to claim 1, wherein the communication client application is arranged to generate a user interface for output on a television screen.

8. A television receiver system according to claim 7, wherein the communication client is arranged to generate a notification of the incoming video call on the user interface responsive to receiving the incoming video call.

9. A television receiver system according to claim 7, wherein the user interface comprises a list of one or more other users of the packet-based communication network associated with the user.

10. A television receiver system according to claim 1, further comprising a remote control unit comprising at least one wireless communication means arranged to transmit data to the processor, a control means coupled to the wireless communication means and configured to control the wireless communication means, and user input means coupled to the control means and arranged to receive input commands from the user and provide the input commands to the control means.

11. A television receiver system according to claim 10, wherein the command to establish a video call is received at the control means from the user input means, and transmitted to the communication client using the at least one wireless communication means.

12. A television receiver system according to claim 10, wherein the remote control unit further comprises a microphone coupled to the control means and arranged to receive audio signals from the user.

13. A television receiver system according to claim 12, wherein the microphone is retractable from the remote control unit, and the control means is arranged to generate the command to establish the video call responsive to the user retracting the microphone and transmit the command to establish the video call to the communication client using the at least one wireless communication means.

14. A television receiver system according to claim 10, wherein the at least one wireless communication means comprises at least one of a radio transmitter and an infra-red transmitter.

15. A television receiver system according to claim 1, wherein the communication client application is arranged to decode audio and video packets received at the processor over the packet-based communication network as audio and video data.

16. A television receiver system according to claim 1, wherein the communication client application is arranged to encode audio and video signals received at the processor as voice over internet protocol packets and video packets for transmission over the packet-based communication network.

17. A television receiver system according to claim 1, wherein the communication client application is programmed to allow the user to establish calls via a peer-to-peer connection in the packet based communication network.

18. A television receiver system according to claim 1, wherein the television receiver system comprises one of a television set and a set-top box arranged to connect to a television set.

19. A media appliance, comprising:
a video playback device operable to retrieve stored video data from a storage location;
a memory storing a communication client application;
a processor, coupled to the memory and operable to execute the communication client application, wherein the communication client application is programmed so as when executed to allow a user to establish a video call with one or more other users via a packet-based communication network;
a video buffer operable to buffer video data for display on a television screen; and
selection means having a first input arranged to receive stored video data from the video playback device, a second input arranged to receive video call data from the communication client, an output connected to the video buffer, and a control input connected to the communication client,
wherein the communication client is arranged to control the selection means to output the video call data to the video buffer responsive to the communication client receiving a command to establish a video call from the user.

20. A media appliance according to claim 19, wherein the media appliance comprises one of a video disc player arranged to connect to a television set, a personal video recorder arranged to connect to a television set, and a games console arranged to connect to a television set.

21. A method of controlling video signals in a television receiver system having a processor executing a communication client, comprising:
receiving broadcast video signals at a television receiver and providing broadcast video data from the television receiver to a first input of a selection means;
outputting the broadcast video data from the selection means to a video buffer in the absence of a selection signal at a control input of the selection means;
receiving a command to establish a video call from a user at the communication client and providing video call data to a second input of the selection means;
responsive to receiving the command to establish a video call, the communication client generating a selection signal to control the selection means to output the video call data to the video buffer.

22. A method of controlling video signals in a media appliance having a processor executing a communication client, comprising:
retrieving stored video data from a storage location using a video playback device and providing the stored video data from the video playback device to a first input of a selection means;
outputting the stored video data from the selection means to a video buffer in the absence of a selection signal at a control input of the selection means;
receiving a command to establish a video call from a user at the communication client and providing video call data to a second input of the selection means;
responsive to receiving the command to establish a video call, the communication client generating a selection signal to control the selection means to output the video call data to the video buffer.
